(19) United States
(12) Patent Application Publication
(10) Pub. No.: US 2026/0094764 A1
(43) Pub. Date: Apr. 2, 2026

(54) MULTILAYER ELECTRONIC COMPONENT

(71) Applicant: Murata Manufacturing Co., Ltd., Nagaokakyo-shi (JP)

(72) Inventor: Shinobu CHIKUMA, Nagaokakyo-shi (JP)

(21) Appl. No.: 19/413,068

(22) Filed: Dec. 9, 2025

Related U.S. Application Data
(63) Continuation of application No. PCT/JP2024/015855, filed on Apr. 23, 2024.

(30) Foreign Application Priority Data
Jun. 20, 2023 (JP) 2023-100985

(51) Int. Cl. H01G 2/06; H01G 4/30

(52) U.S. Cl. CPC H01G 2/065; H01G 4/30

(57) ABSTRACT

A multilayer electronic component includes a multilayer ceramic capacitor and an interposer. End portions of an interposer substrate in a width or length direction and end portions of joint electrodes in the width or length direction are located at a same or substantially a same position in the width direction. The joint electrodes have a plane-symmetric shape centered about an interposer symmetry plane which, in a middle of the width direction or the length direction, extend in the length or width direction and in the stacking direction. The multilayer ceramic capacitor has a plane-symmetric shape centered about a capacitor symmetry plane which, in the middle of the width direction or the length direction, extends in the length or width direction and in the stacking direction. The interposer symmetry plane and the capacitor symmetry plane are on the same or substantially the same plane.

### CROSS REFERENCE TO RELATED APPLICATIONS

This application claims the benefit of priority to Japanese Patent Application No. 2023-100985 filed on June 20, 2023 and is a Continuation Application of PCT Application No. PCT/JP2024/015855 filed on April 23, 2024. The entire contents of each application are hereby incorporated herein by reference.

### BACKGROUND OF THE INVENTION

### 1. Field of the Invention

The present invention relates to multilayer electronic components.

### 2. Description of the Related Art

Conventionally, a multilayer electronic component is provided in which an interposer is provided on a multilayer ceramic capacitor in order to reduce or prevent acoustic noise (see, for example, Japanese Unexamined Patent Application, Publication No. 2014-179583).

The interposer includes a plate-shaped insulating interposer substrate, two bonding electrodes provided on a bonding surface of the interposer substrate adjacent to the multilayer ceramic capacitor, and two mounting electrodes provided on a mounting surface of the interposer substrate. Conventionally, edges of the two bonding electrodes are often located inside the edges of the bonding surface of the interposer substrate. In this case, there is a possibility that the center of the interposer substrate and the center between the two bonding electrodes are misaligned. In this case, even if the interposer and the multilayer ceramic capacitor are aligned, the center of the multilayer ceramic capacitor and the center between the two bonding electrodes may be misaligned, so that the multilayer ceramic capacitor may not be stable on the interposer.

### SUMMARY OF THE INVENTION

Example embodiments of the present invention provide multilayer electronic components that each enable stable placement of a multilayer ceramic capacitor on an interposer.

An example embodiment of the present invention provides a multilayer electronic component that includes a multilayer ceramic capacitor and an interposer attached to the multilayer ceramic capacitor. When a direction in which a plurality of internal electrodes and a plurality of dielectric layers of the multilayer ceramic capacitor are laminated is defined as a lamination direction, a direction between two external electrodes is defined as a length direction, and a direction intersecting the lamination direction and the length direction is defined as a width direction, the interposer includes an interposer substrate including a bonding surface opposed to the multilayer ceramic capacitor, a mounting surface located on an opposite side of the bonding surface in the lamination direction, a first interposer end surface located at one end in the length direction and including a first recessed portion extending in the lamination direction, and a second interposer end surface located at another end in the length direction and including a second recessed portion extending in the lamination direction, a first bonding electrode adjacent to the first interposer end surface on the bonding surface of the interposer substrate, and a second bonding electrode adjacent to the second interposer end surface on the bonding surface of the interposer substrate, a first mounting electrode adjacent to the first interposer end surface on the mounting surface of the interposer substrate, and a second mounting electrode adjacent to the second interposer end surface on the mounting surface of the interposer substrate, a first conductive portion located in the first recessed portion and electrically connecting the first bonding electrode and the first mounting electrode, and a second conductive portion located in the second recessed portion and electrically connecting the second bonding electrode and the second mounting electrode. Portions of the interposer substrate in the width direction, and end portions of the first bonding electrode and end portions of the second bonding electrode in the width direction are respectively located at the same or substantially the same positions in the width direction. The first bonding electrode and the second bonding electrode have a plane-symmetric shape centered on an interposer first symmetry plane extending in the length direction and the lamination direction at a middle of the interposer substrate in the width direction. The multilayer ceramic capacitor has a plane-symmetric shape centered on a capacitor first symmetry plane extending in the length direction and the lamination direction at a middle of the multilayer ceramic capacitor in the width direction. The interposer first symmetry plane and the capacitor first symmetry plane are on a same or substantially a same plane. The end portions of the interposer substrate in the length direction and the end portions of the first bonding electrode and the second bonding electrode in the length direction are respectively located at the same or substantially the same positions in the length direction. The end portions of the first bonding electrode and the second bonding electrode have a plane-symmetric shape centered on an interposer second symmetry plane extending in the width direction and the lamination direction at a middle of the interposer substrate in the length direction. The multilayer ceramic capacitor has a plane-symmetric shape centered on a capacitor second symmetry plane extending in the width direction and the lamination direction at a middle of the multilayer ceramic capacitor in the length direction. The interposer second symmetry plane and the capacitor second symmetry plane are on a same or substantially a same plane.

According to example embodiments of the present invention, multilayer electronic components that each enable stable placement of a multilayer ceramic capacitor on an interposer are provided.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a schematic perspective view of a multilayer electronic component 1 according to a first example embodiment mounted on a substrate 200.

FIG. 2 is a cross-sectional view of the multilayer electronic component 1 according to the first example embodiment taken along the line II-II in FIG. 1.

FIG. 3 is a top view of an interposer 4 according to the first example embodiment of the present invention.

FIG. 4 is a flowchart showing a manufacturing method of the multilayer electronic component 1 according to the first example embodiment of the present invention.

FIGS. 5A-5E are diagrams showing an example of an interposer manufacturing step S2 according to the first example embodiment.

FIG. 6 is a top view of an interposer 4 according to a second example embodiment of the present invention.

FIG. 7 is a top view of an interposer 4 according to a third example embodiment of the present invention.

FIG. 8 is a top view of an interposer 4 in a modified example of the first example embodiment of the present invention.

FIG. 9 is a top view of an interposer 4 in a modified example of the first example embodiment of the present invention.

### DETAILED DESCRIPTION OF THE EXAMPLE EMBODIMENTS

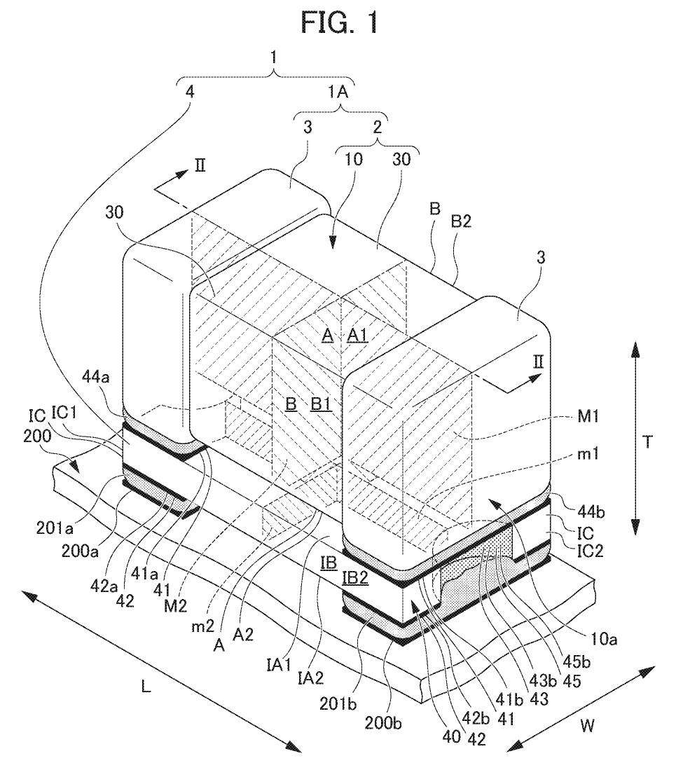

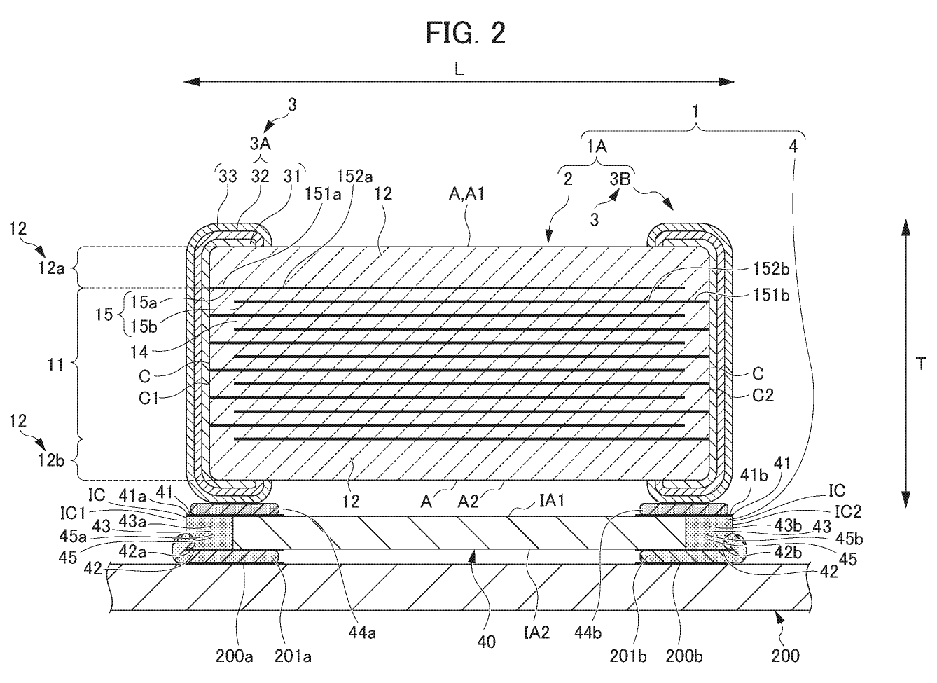

Hereinafter, example embodiments of the present invention will be described with reference to the drawings. FIG. 1 is a schematic perspective view of a multilayer electronic component 1 according to a first example embodiment mounted on a substrate 200. FIG. 2 is a cross-sectional view of the multilayer electronic component 1 according to the first example embodiment taken along the line II-II in FIG. 1.

The multilayer electronic component 1 includes a multilayer ceramic capacitor 1A having a rectangular or substantially rectangular shape and including a multilayer body 2 and a pair of external electrodes 3 provided at both end portions of the multilayer body 2, and an interposer 4 attached to the multilayer ceramic capacitor 1A. The multilayer body 2 includes an inner layer portion 11 including a plurality of sets of a dielectric layer 14 and an internal electrode layer 15.

In the following description, as a term indicating the orientation of the multilayer electronic component 1, the direction in which the pair of external electrodes 3 are provided in the multilayer electronic component 1 is defined as the length direction L. The direction in which the dielectric layers 14 and the internal electrode layers 15 are laminated is defined as the lamination direction T. The direction intersecting both the length direction L and the lamination direction T is defined as the width direction W. In addition, in example embodiments of the present invention, the width direction W is orthogonal or substantially orthogonal to both the length direction L and the lamination direction T.

The multilayer ceramic capacitor 1A includes a multilayer body 2, and external electrodes 3 each provided on a corresponding one of both end surfaces C of the multilayer body 2.

In the following description, among the six outer surfaces of the multilayer body 2, a pair of outer surfaces opposed to each other in the lamination direction T are defined as a first main surface A1 and a second main surface A2, a pair of outer surfaces opposed to each other in the width direction W are defined as a first lateral surface B1 and a second lateral surface B2, and a pair of outer surfaces opposed to each other in the length direction L are defined as a first end surface C1 and a second end surface C2.

When not necessary to particularly distinguish therebetween, the first main surface A1 and the second main surface A2 are collectively referred to as a main surface A, the first lateral surface B1 and the second lateral surface B2 are collectively referred to as a lateral surface B, and the first end surface C1 and the second end surface C2 are collectively referred to as an end surface C.

The multilayer body 2 includes a multilayer body main body 10, and side gap portions 30 each provided on a corresponding one of both lateral surfaces B of the multilayer body main body 10.

The multilayer body main body 10 includes an inner layer portion 11, and outer layer portions 12 each provided on a corresponding one of both main surfaces A of the inner layer portion 11.

The inner layer portion 11 includes a plurality of sets of dielectric layers 14 and internal electrode layers 15 alternately laminated along the lamination direction T. The dielectric layer 14 is made of a ceramic material. As the ceramic material, for example, a dielectric ceramic including BaTiO₃ as a main component is used. Furthermore, a ceramic material obtained by adding at least one subcomponent such as, for example, Mn compounds, Fe compounds, Cr compounds, Co compounds, or Ni compounds to these main components may be used.

The internal electrode layers 15 include a plurality of first internal electrode layers 15a and a plurality of second internal electrode layers 15b. The first internal electrode layers 15a and the second internal electrode layers 15b are alternately provided.

The first internal electrode layer 15a includes a first counter portion 152a opposed to the second internal electrode layer 15b, and a first extension portion 151a extended from the first counter portion 152a toward the first end surface C1 side. The first extension portion 151a includes an end portion which is exposed at the first end surface C1 and is electrically connected to a first external electrode 3A to be described later. The second internal electrode layer 15b includes a second counter portion 152b opposed to the first internal electrode layer 15a, and a second extension portion 151b extended from the second counter portion 152b to the second end surface C2. The second extension portion 151b includes an end portion which is electrically connected to a second external electrode 3B to be described later. Electric charge is accumulated in the first counter portion 152a of the first internal electrode layer 15a and the second counter portion 152b of the second internal electrode layer 15b, such that it functions as a capacitor.

The internal electrode layers 15 are each preferably made of a metal material such as, for example, Ni, Cu, Ag, Pd, Ag-Pd alloy, Au, or the like.

The outer layer portions 12 are each made of the same material as the dielectric layers 14 of the inner layer portion 11.

Side gap portions 30 are each provided on a corresponding one of both lateral surface B of the multilayer body main body 10. The side gap portions 30 cover the end portions of the internal electrode layers 15 in the width direction W exposed on both lateral surfaces of the multilayer body main body 10 along the end portions. The side gap portions 30 are made of the same material as the dielectric layer 14.

The external electrodes 3 include a first external electrode 3A provided on the first end surface C1 of the multilayer body 2 and a second external electrode 3B provided on the second end surface C2 of the multilayer body 2. The external electrodes 3 each cover not only the end surface C, but also a portion of each of the main surfaces A adjacent to the end surface C and a portion of each of the lateral surfaces B adjacent to the end surface C.

As described above, the end portion of the first extension portion 151a of each of the first internal electrode layers 15a is exposed at the first end surface C1 and is electrically connected to the first external electrode 3A. Further, the end portion of the second extension portion 151b of each of the second internal electrode layers 15b is exposed at the second end surface C2 and is electrically connected to the second external electrode 3B. This provides a configuration in which a plurality of capacitor elements are electrically connected in parallel between the first external electrode 3A and the second external electrode 3B.

Further, as shown in FIG. 2, the external electrodes 3 each include a three-layer configuration including a base electrode layer 31, an electrically conductive resin layer 32 provided on the base electrode layer 31, and a plated layer 33 provided on the electrically conductive resin layer 32. In the present example embodiment, each of the external electrodes 3 has a three-layer configuration, but this is not limiting, and it may have a configuration other than three layers, such as a two-layer configuration.

The base electrode layer 31 is formed by, for example, applying and firing an electrically conductive paste including an electrically conductive metal and glass. As the electrically conductive metal of the base electrode layer 31, for example, Cu, Ni, Ag, Pd, Ag-Pd alloy, Au, or the like can be used.

The electrically conductive resin layer 32 covers the base electrode layer 31. The electrically conductive resin layer 32 is an optional configuration including a thermosetting resin and a metal component, for example. As specific examples of the thermosetting resin, various known thermosetting resins such as epoxy resin, phenol resin, urethane resin, silicone resin, and polyimide resin can be used. As the metal component, for example, Ag or metal powder including Ag coating on the surface of a base metal powder can be used.

The plated layer 33 preferably includes plating including, for example, Cu, Ni, Su, Ag, Pd, Ag-Pd alloy, Au, or the like, or an alloy including the metal.

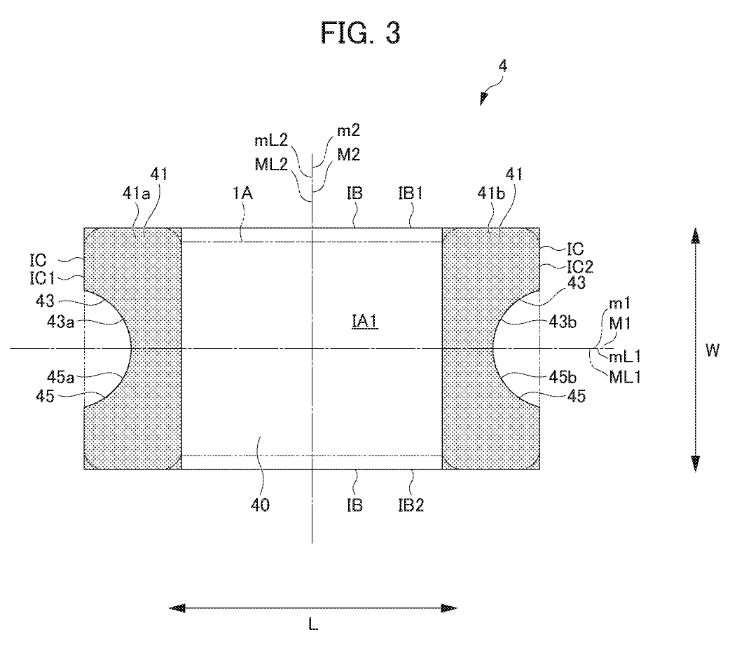

FIG. 3 is a top view of the interposer 4, and the outline of the multilayer ceramic capacitor 1A is shown by a two-dot chain line in FIG. 3. The interposer 4 includes a plate-shaped interposer substrate 40, and a bonding electrode 41 and a mounting electrode 42 provided on the interposer substrate 40.

The interposer substrate 40 includes a single plate material having a rectangular or substantially rectangular parallelepiped shape with an insulating resin as the main material. The interposer substrate 40 is provided to the multilayer ceramic capacitor 1A adjacent to the second main surface A2, and includes a bonding surface IA1 opposed to the second main surface A2 and a mounting surface IA2 on the opposite side of the bonding surface IA1.

In addition, the interposer substrate 40 includes a first interposer end surface IC1 located on one side in the length direction L and a second interposer end surface IC2 located on the other side in the length direction L. When it is not necessary to distinguish between the first interposer end surface IC1 and the second interposer end surface IC2, they are collectively referred to as the interposer end surface IC.

Furthermore, the interposer substrate 40 includes a first interposer lateral surface IB1 located on one side in the width direction W and a second interposer lateral surface IB2 located on the other side in the width direction W. When it is not necessary to distinguish between the first interposer lateral surface IB1 and the second interposer lateral surface IB2, they are collectively referred to as the interposer lateral surface IB.

The first interposer end surface IC1 includes a first recessed portion 45a extending in the lamination direction T at a middle or substantially middle portion in the width direction W. The second interposer end surface IC2 includes a second recessed portion 45b extending in the lamination direction T at a middle or substantially middle portion in the width direction W. When it is not necessary to distinguish between the first recessed portion 45a and the second recessed portion 45b, they are collectively referred to as the recessed portion 45.

At a side of the interposer substrate 40 adjacent to the first external electrode 3A in the length direction L, a first bonding electrode 41a is provided on the bonding surface IA1, and a first mounting electrode 42a is provided on the mounting surface IA2. At a side of the interposer substrate 40 adjacent to the second external electrode 3B in the length direction L, a second bonding electrode 41b is provided on the bonding surface IA1, and a second mounting electrode 42b is provided on the mounting surface IA2.

The first recessed portion 45a includes a first conductive portion 43a that electrically connects the first bonding electrode 41a and the first mounting electrode 42a. The second recessed portion 45b includes a second conductive portion 43b that electrically connects the second bonding electrode 41b and the second mounting electrode 42b. The first conductive portion 43a and the second conductive portion 43b are, for example, metal films. When it is not necessary to distinguish between the first conductive portion 43a and the second conductive portion 43b, they are collectively referred to as the conductive portion 43.

In Feature 1-1 of the present example embodiment, as shown in FIGS. 1 and 3, the end portions of the interposer substrate 40 in the width direction W, that is, the interposer lateral surfaces IB, and the end portions of the first bonding electrode 41a and the second bonding electrode 41b in the width direction W are respectively at the same or substantially the same positions in the width direction W. That is, as shown in FIG. 3, when the interposer 4 is viewed from the bonding surface IA1, the end portions i of the interposer substrate 40n in the width direction W and the end portions of the first bonding electrode 41a and the second bonding electrode 41b in the width direction W coincide with each other. In other words, as shown in FIG. 3, when the interposer 4 is viewed from the bonding surface IA1, the end portions of the interposer substrate 40 in the width direction W and the end portions of the first bonding electrode 41a and the second bonding electrode 41b in the width direction W are aligned.

In the present specification, "the end portions are at the same position", "the end portions coincide with each other", or "the end portions are aligned" includes a certain degree of error, and includes cases where there is a deviation of, for example, about ±100 μm.

In addition, as shown in FIGS. 1 and 3, according to Feature 1-2 of the present example embodiment, the first bonding electrode 41a and the second bonding electrode 41b have a plane-symmetric shape centered on an interposer first symmetry plane m1 extending in the length direction L and the lamination direction T at the middle in the width direction W of the interposer substrate 40. That is, when viewed in the plane shown in FIG. 3, the first bonding electrode 41a and the second bonding electrode 41b have a line-symmetric shape centered on an interposer first symmetry line mL1 extending in the length direction L at the middle in the width direction W of the interposer substrate 40.

Furthermore, as shown in FIGS. 1 and 3, according to Feature 1-3 of the present example embodiment, the multilayer ceramic capacitor 1A has a plane-symmetric shape centered on a capacitor first symmetry plane M1 extending in the length direction L and the lamination direction T at the middle in the width direction W of the multilayer ceramic capacitor 1A. That is, when viewed in the plane shown in FIG. 3, the multilayer ceramic capacitor 1A shown by the two-dot chain line has a line-symmetric shape centered on a capacitor first symmetry line ML1 extending in the length direction L at the middle in the width direction W of the multilayer ceramic capacitor 1A.

According to Feature 1-4 of the present example embodiment, the interposer first symmetry plane m1, the interposer first symmetry line mL1, the capacitor first symmetry plane M1, and the capacitor first symmetry line ML1 are on the same or substantially the same plane.

According to Feature 2-1 of the present example embodiment, as shown in FIGS. 1 and 3, the end portions of the interposer substrate 40 in the length direction L, that is, the interposer end surfaces IC, and the end portions of the first bonding electrode 41a and the second bonding electrode 41b in the length direction L are respectively at the same or substantially the same positions. That is, as shown in FIG. 3, when the interposer 4 is viewed from the bonding surface IA1, the end portion in the length direction L of the interposer substrate 40 and the end portions of the first bonding electrode 41a and the second bonding electrode 41b in the length direction L coincide with each other. In other words, as shown in FIG. 3, when the interposer 4 is viewed from the bonding surface IA1, the end portion in the length direction L of the interposer substrate 40 and the end portions of the first bonding electrode 41a and the second bonding electrode 41b in the length direction L are aligned.

Further, as shown in FIGS. 1 and 3, according to Feature 2-2 of the present example embodiment, the first bonding electrode 41a and the second bonding electrode 41b have a plane-symmetric shape centered on the interposer second symmetry plane m2 extending in the width direction W and the lamination direction T at the middle in the length direction L of the interposer substrate 40. That is, when viewed in the plane shown in FIG. 3, the first bonding electrode 41a and the second bonding electrode 41b have a line-symmetric shape centered on the interposer second symmetry line mL2 extending in the width direction W at the middle in the length direction L of the interposer substrate 40.

Furthermore, as shown in FIGS. 1 and 3, according to Feature 2-3 of the present example embodiment, the multilayer ceramic capacitor 1A has a plane-symmetric shape centered on the capacitor second symmetry plane M2 extending in the width direction W and the lamination direction T at the middle in the length direction L of the multilayer ceramic capacitor 1A. That is, when viewed in the plane shown in FIG. 3, the multilayer ceramic capacitor 1A shown by the two-dot chain line has a line-symmetric shape centered on the capacitor second symmetry line ML2 extending in the width direction W at the middle in the length direction L of the multilayer ceramic capacitor 1A.

According to Feature 2-4 of the present example embodiment, the interposer second symmetry plane m2 and the interposer second symmetry line mL2 are on the same or substantially the same plane as the capacitor second symmetry plane M2 and the capacitor second symmetry line ML2.

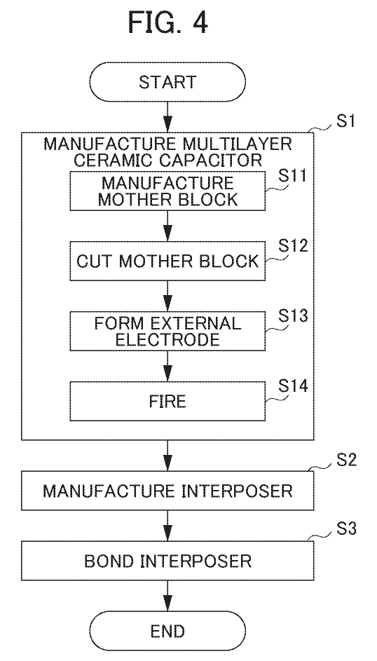

FIG. 4 is a flowchart showing an example of a manufacturing method of the multilayer electronic component 1. The manufacturing method of the multilayer electronic component 1 includes a multilayer ceramic capacitor manufacturing step S1, an interposer manufacturing step S2, and an interposer bonding step S3.

The multilayer ceramic capacitor manufacturing step S1 includes a mother block manufacturing step S11, a mother block cutting step S12, an external electrode forming step S13, and a firing step S14.

First, an electrically conductive paste for manufacturing the internal electrode layer 15 is printed on a ceramic green sheet for manufacturing the dielectric layer 14 so as to have a strip-shaped pattern, such that a material sheet is prepared. Subsequently, a plurality of material sheets are stacked such that the strip-shaped conductor patterns face the same direction and the strip-shaped conductor patterns are shifted by about half a pitch in the width direction W between adjacent material sheets. Furthermore, ceramic green sheets for manufacturing the outer layer portion 12 are stacked on both sides of the plurality of laminated material sheets. Then, the stacked ceramic green sheets for manufacturing the outer layer portion and the plurality of material sheets are thermocompression bonded. Thus, a mother block is formed.

Next, the mother block is cut to manufacture a plurality of multilayer body main bodies 10. Next, the side gap portion 30 is formed by attaching a ceramic green sheet for manufacturing a side gap to the side portion of the multilayer body main body 10 where the internal electrode layers 15 are exposed.

Subsequently, the base electrode layer 31, the electrically conductive resin layer 32, and the plated layer 33 are sequentially formed at both end portions of the multilayer body 2 to form the external electrodes 3.

Then, heating is performed for a predetermined time in a nitrogen atmosphere at a set firing temperature. Thus, the external electrode 3 is fired on the multilayer body 2 to manufacture the multilayer ceramic capacitor 1A.

The multilayer ceramic capacitor 1A is manufactured to have a plane-symmetric shape centered on the capacitor first symmetry plane M1 extending in the length direction L and the lamination direction T at the middle in the width direction W of the multilayer ceramic capacitor 1A (Feature 1-3), and to have a plane-symmetric shape centered on the capacitor second symmetry plane M2 extending in the width direction W and the lamination direction T at the middle in the length direction L (Feature 2-3).

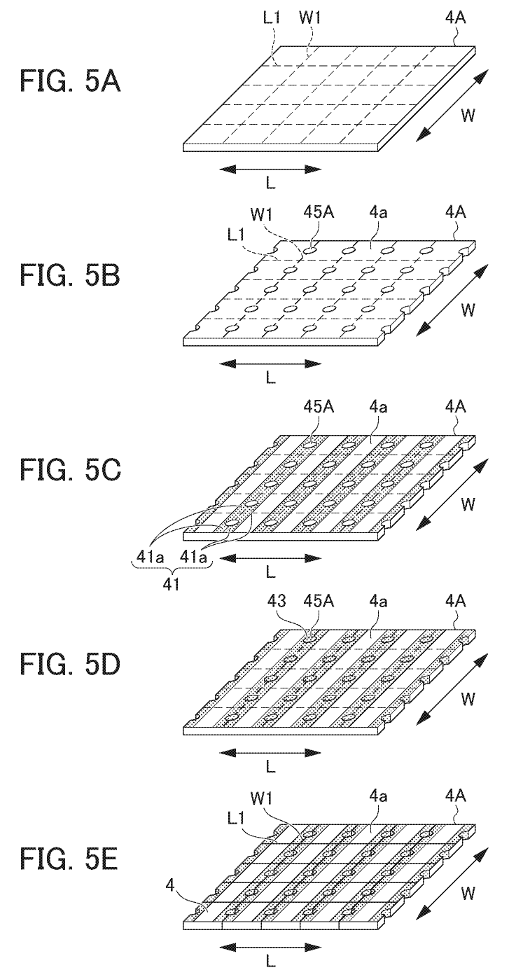

FIGS. 5A-5E are diagrams showing an example of the interposer manufacturing step S2. As shown in FIG. 5A, one large plate member 4A is prepared. This plate member 4A is cut along a plurality of cutting lines L1 extending in the length direction L and spaced apart from each other in the width direction W at intervals corresponding to the width of the interposer 4, and a plurality of cutting lines W1 extending in the width direction W and spaced apart from each other in the length direction L at intervals corresponding to the length of the interposer 4, such that a plurality of interposers 4 are manufactured. The cutting lines L1 and cutting lines W1 are shown by dotted lines in FIGS. 5A-5E.

As shown in FIG. 5B, a plurality of through holes 45A having a shape in which two recessed portions 45 are opposed to each other are formed on the cutting lines W1 of the plate member 4A.

As shown in FIG. 5C, bonding electrodes 41 are printed on the bonding surface IA1 of the plate member 4A. Although not shown, mounting electrodes 42 are similarly printed on the mounting surface IA2 of the plate member 4A.

At this time, the first bonding electrode 41a of the interposer 4 and the second bonding electrode 41b of the interposer 4 adjacent in the length direction L to said interposer 4 are printed integrally. The first bonding electrode 41a of the interposer 4 and the first bonding electrode 41a of the interposer 4 adjacent in the width direction W to said interposer 4 are printed integrally. The second bonding electrode 41b of the interposer 4 and the second bonding electrode 41b of the interposer 4 adjacent in the width direction W to said interposer 4 are printed integrally. That is, the bonding electrodes 41 are printed in a band shape extending along the cutting lines W1 and having a constant width centered on the cutting lines W1.

Although illustration and description are omitted, mounting electrodes 42 are printed on the surface that corresponds to the mounting surface 4b of the plate member 4A in the same or substantially the same manner as the bonding electrodes 41.

Next, as shown in FIG. 5D, a metal film is formed which defines and functions as a conductive portion 43 on the inner surface of the through hole 45A to electrically connect the bonding electrode 41 and the mounting electrode 42.

Thereafter, as shown in FIG. 5E, the plate member 4A is cut along the cutting lines W1 and the cutting lines L1 to manufacture a plurality of interposers 4. At this time, the bonding electrodes 41 are continuously formed between adjacent interposers 4, and the interposer substrate 40 is cut together with the bonding electrodes 41.

As a result, as shown in FIG. 3, the end portions of the interposer substrate 40 in the width direction W, and the end portions of the first bonding electrode 41a and the end portions of the second bonding electrode 41b in the width direction W are respectively at the same or substantially the same positions in the width direction W (Features 1-1). The end portions of the interposer substrate 40 in the length direction L and the end portions of the first bonding electrode 41a and the second bonding electrode 41b in the length direction L are respectively at the same or substantially the same position (Feature 2-1).

The first bonding electrode 41a and the second bonding electrode 41b have a line-symmetric shape centered on the interposer first symmetry line mL1 extending in the length direction L at the middle of the interposer substrate 40 in the width direction W.

That is, the first bonding electrode 41a and the second bonding electrode 41b have a plane-symmetric shape centered on the interposer first symmetry plane m1 extending in the length direction L and the lamination direction T at the middle of the interposer substrate 40 in the width direction W (Feature 1-2).

Further, the first bonding electrode 41a and the second bonding electrode 41b have a line-symmetric shape centered on the interposer second symmetry line mL2 extending in the width direction W at the middle of the interposer substrate 40 in the length direction L.

That is, the first bonding electrode 41a and the second bonding electrode 41b have a plane-symmetric shape centered on the interposer second symmetry plane m2 extending in the width direction W and the lamination direction T at the middle of the interposer substrate 40 in the length direction L (Feature 2-2).

Next, the bonding surface IA1 of the interposer substrate 40 is attached to the second main surface A2 of the multilayer ceramic capacitor 1A.

At this time, the first bonding electrode 41a of the interposer 4 and the first external electrode 3A of the multilayer ceramic capacitor 1A are joined by solder 44a. The second bonding electrode 41b of the interposer 4 and the second external electrode 3B of the multilayer ceramic capacitor 1A are joined by solder 44b. At this time, the interposer first symmetry plane m1 is made to be on the same or substantially the same plane as the capacitor first symmetry plane M1, and the interposer second symmetry plane m2 is made to be on the same or substantially the same plane as the capacitor second symmetry plane M2 (Feature 1-4) and (Feature 2-4). Thus, the multilayer electronic component 1 shown in FIG. 1 is manufactured.

After this, the multilayer electronic component 1 is mounted on the substrate 200. At this time, the first mounting electrode 42a of the interposer 4 is bonded by solder 201a to the first substrate electrode 200a provided on the substrate 200. The second mounting electrode 42b is bonded by solder 201b to the second substrate electrode 200b provided on the substrate 200.

At this time, since the solder 201a and the solder 201b enter into the recessed portions 45 provided in each of the pair of interposer end surfaces IC of the interposer substrate 40, it is possible to reduce or prevent the solder 201a and the solder 201b from spreading up on the interposer end surfaces IC.

The multilayer electronic component 1 is mounted on the substrate 200, and the first external electrode 3A, the first bonding electrode 41a, the first conductive portion 43a, the first mounting electrode 42a, and the first substrate electrode 200a are electrically connected. Further, the second external electrode 3B, the second bonding electrode 41b, the second conductive portion 43b, the second mounting electrode 42b, and the second substrate electrode 200b are electrically connected.

Suppose that, unlike Feature 1-1 of the present example embodiment, the end portions of the interposer substrate 40 in the width direction W and the end portions of the first bonding electrode 41a and the second bonding electrode 41b in the width direction W are respectively not at the same or substantially the same positions in the width direction W. Then, unlike Feature 1-2 of the present example embodiment, the center of the first bonding electrode 41a and the second bonding electrode 41b in the width direction W may deviate from the interposer first symmetry plane m1 at the center of the interposer substrate 40 in the width direction W. In this case, even if the multilayer ceramic capacitor 1A and the interposer 4 are bonded by aligning the capacitor first symmetry plane M1 (Feature 1-3), which is the center of the multilayer ceramic capacitor 1A in the width direction W, with the interposer first symmetry plane m1 (Feature 1-4), the center of the first bonding electrode 41a and the second bonding electrode 41b in the width direction W may deviate from the capacitor first symmetry plane M1. Then, the multilayer ceramic capacitor 1A becomes unstable on the interposer 4.

However, in the present example embodiment, the end portions of the interposer substrate 40 in the width direction W and the end portions of the first bonding electrode 41a and the end portions of the second bonding electrode 41b in the width direction W are respectively at the same or substantially the same positions in the width direction W (Feature 1-1). Then, the center of the first bonding electrode 41a and the second bonding electrode 41b in the width direction W extend the interposer first symmetry plane m1 at the center of the interposer substrate 40 in the width direction W (Feature 1-2). In this case, when the multilayer ceramic capacitor 1A and the interposer 4 are bonded by aligning the capacitor first symmetry plane M1 (Feature 1-3), which is the center of the multilayer ceramic capacitor 1A in the width direction W, with the interposer first symmetry plane m1 (Feature 1-4), the center of the first bonding electrode 41a and the second bonding electrode 41b in the width direction W extends to the capacitor first symmetry plane M1. Therefore, the multilayer ceramic capacitor 1A is stable on the interposer 4.

Suppose that, unlike Feature 2-1 of the present example embodiment, the end portions of the interposer substrate 40 in the length direction L and the end portions of the first bonding electrode 41a and the second bonding electrode 41b in the length direction L are respectively not at the same or substantially the same positions in the length direction L. Then, unlike Feature 2-2 of the present example embodiment, the center of the first bonding electrode 41a and the second bonding electrode 41b in the length direction L may deviate from the interposer second symmetry plane m2 at the center of the interposer substrate 40 in the length direction L. In this case, even if the multilayer ceramic capacitor 1A and the interposer 4 are bonded by aligning the capacitor second symmetry plane M2 (Feature 2-3), which is the center of the multilayer ceramic capacitor 1A in the length direction L, with the interposer second symmetry plane m2, the center of the first bonding electrode 41a and the second bonding electrode 41b in the length direction L may deviate from the capacitor second symmetry plane M2. Then, the multilayer ceramic capacitor 1A becomes unstable on the interposer 4.

However, in the present example embodiment, the end portions of the interposer substrate 40 in the length direction L and the end portions of the first bonding electrode 41a and the second bonding electrode 41b in the length direction L are respectively at the same or substantially the same positions in the length direction L (Feature 2-1). Then, the center of the first bonding electrode 41a and the second bonding electrode 41b in the length direction L extends to the interposer second symmetry plane m2 at the center of the interposer substrate 40 in the length direction L (Feature 2-2). In this case, when the multilayer ceramic capacitor 1A and the interposer 4 are bonded by aligning the capacitor second symmetry plane M2 (Feature 2-3), which is the center of the multilayer ceramic capacitor 1A in the length direction L, with the interposer second symmetry plane m2 (Feature 2-4), the center of the first bonding electrode 41a and the second bonding electrode 41b in the length direction L reaches the capacitor second symmetry plane M2. Therefore, it is possible to stably provide the multilayer ceramic capacitor 1A on the interposer 4.

The first example embodiment has the following advantageous features.

With Feature 1-1, the end portions of the interposer substrate 40 in the width direction W, that is, the interposer lateral surfaces IB, and the end portions of the first bonding electrode 41a and the end portions of the second bonding electrode 41b in the width direction W are respectively at the same or substantially the same positions in the width direction W.

With Feature 2-1, the end portions of the interposer substrate 40 in the length direction L, that is, the surfaces other than the recessed portions 45 of the interposer end surfaces IC, and the end portions of the first bonding electrode 41a and the second bonding electrode 41b in the length direction L are respectively at the same or substantially the same positions.

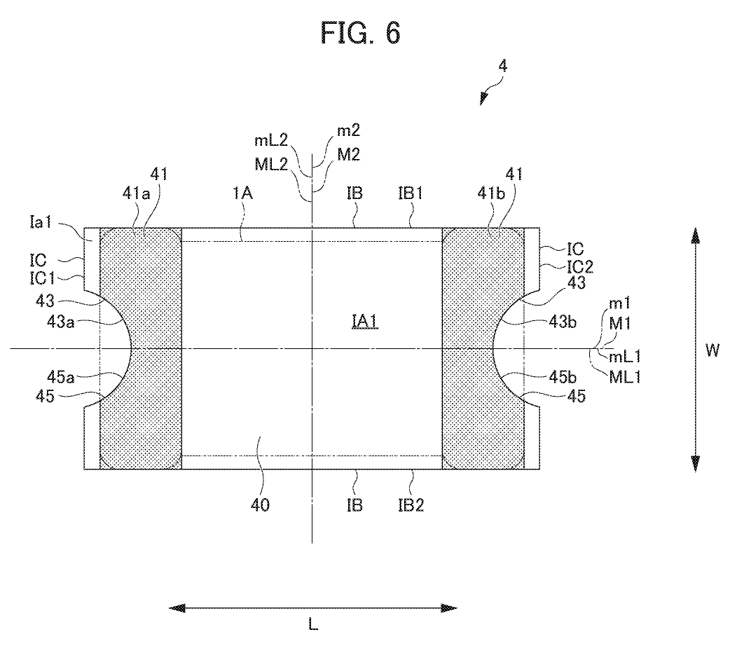

However, a second example embodiment of the present invention includes Feature 1-1 but does not include Feature 2-1. FIG. 6 is a view corresponding to FIG. 2 of the first example embodiment and is a top view of the interposer 4 of the second example embodiment. In the interposer 4 of the second example embodiment, the interposer end surfaces IC are respectively not at the same or substantially the same positions in the length direction L as the end portions of the first bonding electrode 41a and the second bonding electrode 41b in the length direction L, and are located further outward. In addition, "outward" indicates a direction away from the center of the interposer. That is, the bonding surface IA1 of the interposer substrate 40 has a length direction margin region Ia1 where the first bonding electrode or the second bonding electrode is not provided, outward in the length direction from the end portion of the first bonding electrode 41a in the length direction or the end portion of the second bonding electrode 41b in the length direction.

The second example embodiment does not provide the advantageous effects of Features 2-1 to 2-4 of the first example embodiment, but provides the advantageous effects of Features 1-1 to 1-4, such that it provides advantageous effects on stabilization of the multilayer ceramic capacitor 1A on the interposer 4.

Furthermore, due to the presence of the length direction margin region Ia1, when providing the multilayer ceramic capacitor 1 on the interposer 4, neither of the end portions of the interposer 4 in the length direction L are not hidden by the multilayer ceramic capacitor 1, such that it is easy to provide the multilayer ceramic capacitor 1 on the interposer 4.

### Third Example Embodiment

The first example embodiment has the following advantageous features.

With Feature 1-1, the end portions of the interposer substrate 40 in the width direction W, that is, the interposer lateral surfaces IB, and the end portions of the first bonding electrode 41a and the end portions of the second bonding electrode 41b in the width direction W are respectively at the same or substantially the same positions in the width direction W.

With Feature 2-1, the end portions of the interposer substrate 40 in the length direction L, that is, the surfaces other than the recessed portions 45 of the interposer end surfaces IC, and the end portions of the first bonding electrode 41a and the second bonding electrode 41b in the length direction L are respectively at the same or substantially the same positions.

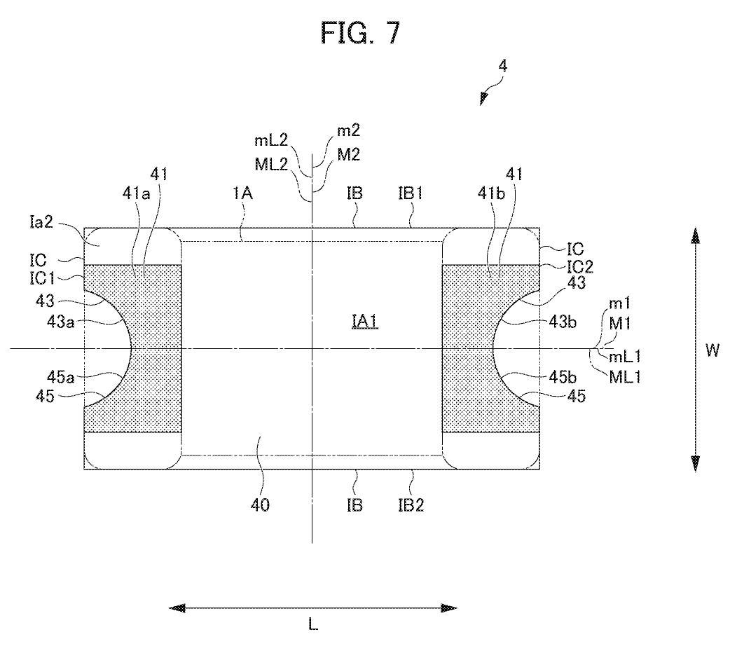

However, a third example embodiment of the present invention includes Feature 2-1 but does not include Feature 1-1. FIG. 7 is a view corresponding to FIG. 3 of the first example embodiment and is a top view of the interposer 4 of the third example embodiment. In the interposer 4 of the third example embodiment, the interposer lateral surfaces IB are respectively not at the same or substantially the same positions in the width direction W as the end portions of the first bonding electrode 41a and the second bonding electrode 41b in the width direction W, and are located further outward. That is, the bonding surface IA1 of the interposer substrate 40 includes a width direction margin region Ia2 where the first bonding electrode 41a or the second bonding electrode 41b is not provided, outward in the width direction W from each of the end portions of the first bonding electrode 41a in the width direction W or each of the end portions of the second bonding electrode 41b in the width direction W.

The third example embodiment does not provide the advantageous effects of Features 1-1 to 1-4 of the first example embodiment, but provides the advantageous effects of Features 2-1 to 2-4, such that it provides advantageous effects on stabilization of the multilayer ceramic capacitor 1A on the interposer 4.

Furthermore, due to the presence of the width direction margin region Ia2, when providing the multilayer ceramic capacitor 1 on the interposer 4, neither of the end portions of the interposer 4 in the width direction W are hidden by the multilayer ceramic capacitor 1, such that it is easy to provide the multilayer ceramic capacitor 1 on the interposer 4.

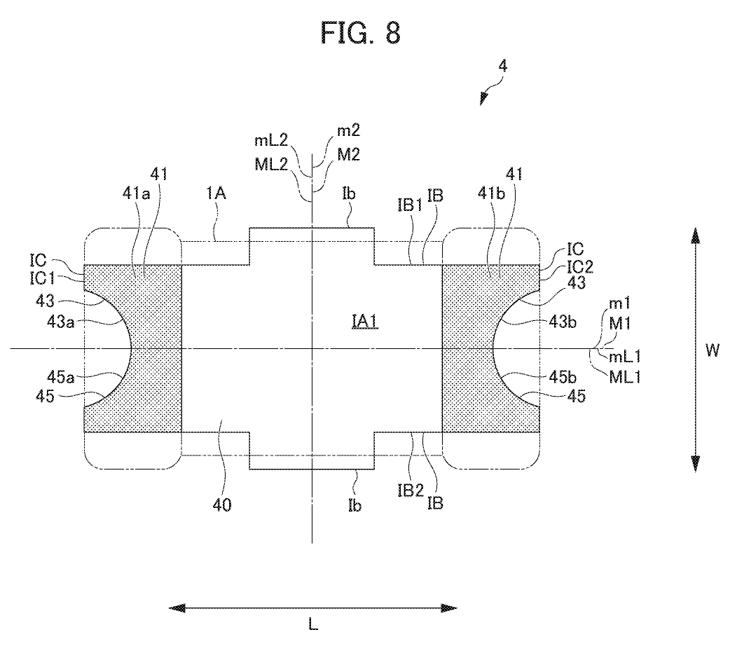

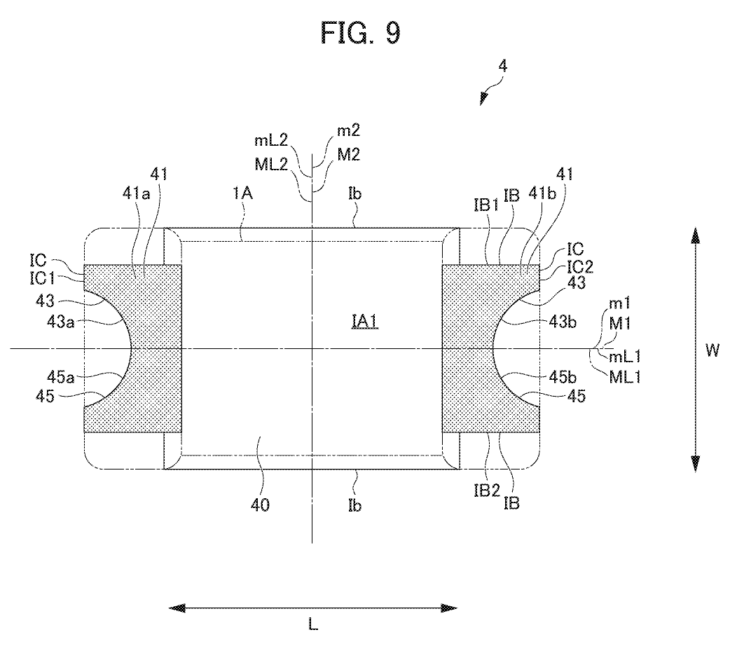

FIGS. 8 and 9 each show a modified example of the first example embodiment of the present invention. The differences from the first example embodiment are that the interposer lateral surfaces IB are not single flat surfaces, the interposer lateral surfaces IB include portions at the same or substantially the same positions in the width direction W as the end portions of the first bonding electrode 41a and the end portions of the second bonding electrode 41b in the width direction W, and the interposer lateral surfaces IB also include protruding portions Ib that respectively protrude outward from the end portions of the first bonding electrode 41a and the second bonding electrode 41b in the width direction W. FIG. 8 shows a configuration in which the protruding portions Ib are each provided at a portion closer to the middle in the length direction L than the portions where the first bonding electrode 41a and the second bonding electrode 41b are provided on the bonding surface IA1. FIG. 9 shows a configuration in which the protruding portions Ib are each provided at a portion closer to the middle in the length direction L that partially overlaps with the portion where the first bonding electrode 41a or the second bonding electrode 41b is provided, on the bonding surface IA1. These modified examples also have the following advantageous features similar to the first example embodiment.

According to Feature 1-1, at the end portions of the first bonding electrode 41a and the end portions the second bonding electrode 41b in the width direction W, there are portions at the same positions in the width direction W as the end portions of the interposer substrate 40 in the width direction W, that is, the interposer lateral surfaces IB.

In addition, according to Feature 1-2, the first bonding electrode 41a and the second bonding electrode 41b have a plane-symmetric shape centered on the interposer first symmetry plane m1 extending in the length direction L and the lamination direction T at the middle in the width direction W of the interposer substrate 40.

Furthermore, according to Feature 1-3, the multilayer ceramic capacitor 1A has a plane-symmetric shape centered on the capacitor first symmetry plane M1 extending in the length direction L and the lamination direction T at the middle in the width direction W of the multilayer ceramic capacitor 1A.

According to Feature 1-4, the interposer first symmetry plane m1, the interposer first symmetry line mL1, the capacitor first symmetry plane M1, and the capacitor first symmetry line ML1 are on the same or substantially the same plane.

According to Feature 2-1, the end portions of the interposer substrate 40 in the length direction L, that is, the surfaces other than the recessed portions 45 of the interposer end surfaces IC, and the end portions of the first bonding electrode 41a and the second bonding electrode 41b in the length direction L are respectively at the same or substantially the same positions.

In addition, according to Feature 2-2, the first bonding electrode 41a and the second bonding electrode 41b have a plane-symmetric shape centered on the interposer second symmetry plane m2 extending in the width direction W and the lamination direction T at the middle in the length direction L of the interposer substrate 40.

Furthermore, according to Feature 2-3, the multilayer ceramic capacitor 1A has a plane-symmetric shape centered on the capacitor second symmetry plane M2 extending in the width direction W and the lamination direction T at the middle in the length direction L of the multilayer ceramic capacitor 1A.

According to Feature 2-4, the interposer second symmetry plane m2 and the interposer second symmetry line mL2 are on the same or substantially the same plane as the capacitor second symmetry plane M2 and the capacitor second symmetry line ML2.

Therefore, they have the same or substantially the same advantageous effects as the first example embodiment.

Although example embodiments of the present invention have been described above, the present invention is not limited to the above-described example embodiments, and various changes and modifications including the following are possible.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A multilayer electronic component comprising:
a multilayer ceramic capacitor; and
an interposer attached to the multilayer ceramic capacitor; wherein
the multilayer ceramic capacitor includes:
a multilayer body including a dielectric layer, an inner electrode layer laminated on the dielectric layer, a first main surface and a second main surface facing each other in a lamination direction, a first side surface and a second side surface facing each other in a width direction orthogonal to the lamination direction, and a first end surface and a second end surface facing each other in a length direction orthogonal to the lamination direction and the width direction;
a first outer electrode on the first main surface and the first end surface of the multilayer body; and
a second outer electrode on the first main surface and the second end surface of the multilayer body;
the interposer includes:
an interposer substrate including a bonding surface opposed to the multilayer ceramic capacitor, a mounting surface located on an opposite side of the bonding surface, a first interposer end surface located at one end in the length direction and provided with a first recessed portion, and a second interposer end surface located at one other end in the length direction and provided with a second recessed portion;
a first bonding electrode adjacent to the first interposer end surface on the bonding surface of the interposer substrate, and a second bonding electrode adjacent to the second interposer end surface on the bonding surface of the interposer substrate;
a first mounting electrode adjacent to the first interposer end surface on the mounting surface of the interposer substrate, and a second mounting electrode adjacent to the second interposer end surface on the mounting surface of the interposer substrate;
a first conductive portion located in the first recessed portion and electrically connecting the first bonding electrode and the first mounting electrode; and
a second conductive portion located in the second recessed portion and electrically connecting the second bonding electrode and the second mounting electrode;
end portions of the interposer substrate in a first direction orthogonal to the length direction, and end portions of the first bonding electrode and end portions of the second bonding electrode in the first direction are respectively located at the same or substantially the same positions in the first direction;
the first bonding electrode and the second bonding electrode have a plane-symmetric shape centered on an interposer first symmetry plane extending in the length direction and a second direction at a middle of the interposer substrate in the first direction;
the multilayer ceramic capacitor has a plane-symmetric shape centered on a capacitor first symmetry plane extending in the length direction and the lamination direction at a middle of the multilayer ceramic capacitor in the width direction;
the interposer first symmetry plane and the capacitor first symmetry plane are on the same or substantially the same plane;
the end portions of the interposer substrate in the length direction and the end portions of the first bonding electrode and the second bonding electrode in the length direction are respectively located at the same or substantially the same positions in the length direction;
the end portions of the first bonding electrode and the second bonding electrode have a plane-symmetric shape centered on an interposer second symmetry plane extending in the first direction and the second direction at a middle of the interposer substrate in the length direction;
the multilayer ceramic capacitor has a plane-symmetric shape centered on a capacitor second symmetry plane extending in the width direction and the lamination direction at a middle of the multilayer ceramic capacitor in the length direction; and
the interposer second symmetry plane and the capacitor second symmetry plane are on the same or substantially the same plane.

2. A multilayer electronic component comprising:
a multilayer ceramic capacitor; and
an interposer attached to the multilayer ceramic capacitor; wherein
the multilayer ceramic capacitor includes:
a multilayer body including a dielectric layer, an inner electrode layer laminated on the dielectric layer, a first main surface and a second main surface facing each other in a lamination direction, a first side surface and a second side surface facing each other in a width direction orthogonal to the lamination direction, and a first end surface and a second end surface facing each other in a length direction orthogonal to the lamination direction and the width direction;
a first outer electrode on the first main surface and the first end surface of the multilayer body; and
a second outer electrode on the first main surface and the second end surface of the multilayer body;
the interposer includes:
an interposer substrate including a bonding surface opposed to the multilayer ceramic capacitor, a mounting surface located on an opposite side of the bonding surface, a first interposer end surface located at one end in the length direction and provided with a first recessed portion, and a second interposer end surface located at one other end in the length direction and provided with a second recessed portion;
a first bonding electrode adjacent to the first interposer end surface on the bonding surface of the interposer substrate, and a second bonding electrode adjacent to the second interposer end surface on the bonding surface of the interposer substrate;
a first mounting electrode adjacent to the first interposer end surface on the mounting surface of the interposer substrate, and a second mounting electrode adjacent to the second interposer end surface on the mounting surface of the interposer substrate;
a first conductive portion located in the first recessed portion and electrically connecting the first bonding electrode and the first mounting electrode; and
a second conductive portion located in the second recessed portion and electrically connecting the second bonding electrode and the second mounting electrode;
end portions of the interposer substrate in a first direction orthogonal to the length direction, and end portions of the first bonding electrode and end portions of the second bonding electrode in the first direction are respectively located at the same or substantially the same positions in the first direction;
the first bonding electrode and the second bonding electrode have a plane-symmetric shape centered on an interposer first symmetry plane extending in the length direction and a second direction at a middle of the interposer substrate in the first direction;
the multilayer ceramic capacitor has a plane-symmetric shape centered on a capacitor first symmetry plane extending in the length direction and the lamination direction at a middle of the multilayer ceramic capacitor in the width direction;
the interposer first symmetry plane and the capacitor first symmetry plane are on the same or substantially the same plane.

3. A multilayer electronic component comprising:
a multilayer ceramic capacitor; and
an interposer attached to the multilayer ceramic capacitor; wherein
the multilayer ceramic capacitor includes:
a multilayer body including a dielectric layer, an inner electrode layer laminated on the dielectric layer, a first main surface and a second main surface facing each other in a lamination direction, a first side surface and a second side surface facing each other in a width direction orthogonal to the lamination direction, and a first end surface and a second end surface facing each other in a length direction orthogonal to the lamination direction and the width direction;
a first outer electrode on the first main surface and the first end surface of the multilayer body; and
a second outer electrode on the first main surface and the second end surface of the multilayer body;
the interposer includes:
an interposer substrate including a bonding surface opposed to the multilayer ceramic capacitor, a mounting surface located on an opposite side of the bonding surface, a first interposer end surface located at one end in the length direction and provided with a first recessed portion, and a second interposer end surface located at one other end in the length direction and provided with a second recessed portion;
a first bonding electrode adjacent to the first interposer end surface on the bonding surface of the interposer substrate, and a second bonding electrode adjacent to the second interposer end surface on the bonding surface of the interposer substrate;
a first mounting electrode adjacent to the first interposer end surface on the mounting surface of the interposer substrate, and a second mounting electrode adjacent to the second interposer end surface on the mounting surface of the interposer substrate;
a first conductive portion located in the first recessed portion and electrically connecting the first bonding electrode and the first mounting electrode; and
a second conductive portion located in the second recessed portion and electrically connecting the second bonding electrode and the second mounting electrode;
the end portions of the interposer substrate in the length direction and the end portions of the first bonding electrode and the second bonding electrode in the length direction are respectively located at the same or substantially the same positions in the length direction;
the end portions of the interposer substrate in the length direction and the end portions of the first bonding electrode and the second bonding electrode in the length direction are respectively located at the same or substantially the same positions in the length direction;
the end portions of the first bonding electrode and the second bonding electrode have a plane-symmetric shape centered on an interposer second symmetry plane extending in a first direction orthogonal to the length direction and a second direction at a middle of the interposer substrate in the length direction;
the multilayer ceramic capacitor has a plane-symmetric shape centered on a capacitor second symmetry plane extending in the width direction and the lamination direction at a middle of the multilayer ceramic capacitor in the length direction; and
the interposer second symmetry plane and the capacitor second symmetry plane are on the same or substantially the same plane.

4. The multilayer electronic component according to claim 1, wherein the bonding surface of the interposer substrate includes a length direction margin region where the first bonding electrode and the second bonding electrode are not provided, outward in the length direction from an end portion of the first bonding electrode in the length direction or an end portion of the second bonding electrode in the length direction.

5. The multilayer electronic component according to claim 2, wherein the bonding surface of the interposer substrate includes a length direction margin region where the first bonding electrode and the second bonding electrode are not provided, outward in the length direction from an end portion of the first bonding electrode in the length direction or an end portion of the second bonding electrode in the length direction.

6. The multilayer electronic component according to claim 3, wherein the bonding surface of the interposer substrate includes a length direction margin region where the first bonding electrode and the second bonding electrode are not provided, outward in the length direction from an end portion of the first bonding electrode in the length direction or an end portion of the second bonding electrode in the length direction.

7. The multilayer electronic component according to claim 1, wherein the bonding surface of the interposer substrate includes a second direction margin region where the first bonding electrode and the second bonding electrode are not provided, outward in the second direction from each of the end portions of the first bonding electrode in the second direction or each of the end portions of the second bonding electrode in the second direction.

8. The multilayer electronic component according to claim 2, wherein the bonding surface of the interposer substrate includes a second direction margin region where the first bonding electrode and the second bonding electrode are not provided, outward in the second direction from each of the end portions of the first bonding electrode in the second direction or each of the end portions of the second bonding electrode in the second direction.

9. The multilayer electronic component according to claim 3, wherein the bonding surface of the interposer substrate includes a second direction margin region where the first bonding electrode and the second bonding electrode are not provided, outward in the second direction from each of the end portions of the first bonding electrode in the second direction or each of the end portions of the second bonding electrode in the second direction.

10. The multilayer electronic component according to claim 4, wherein the bonding surface of the interposer substrate includes a second direction margin region where the first bonding electrode and the second bonding electrode are not provided, outward in the second direction from each of the end portions of the first bonding electrode in the second direction or each of the end portions of the second bonding electrode in the second direction.

11. The multilayer electronic component according to claim 5, wherein the bonding surface of the interposer substrate includes a second direction margin region where the first bonding electrode and the second bonding electrode are not provided, outward in the second direction from each of the end portions of the first bonding electrode in the second direction or each of the end portions of the second bonding electrode in the second direction.

12. The multilayer electronic component according to claim 6, wherein the bonding surface of the interposer substrate includes a second direction margin region where the first bonding electrode and the second bonding electrode are not provided, outward in the second direction from each of the end portions of the first bonding electrode in the second direction or each of the end portions of the second bonding electrode in the second direction.

13. The multilayer electronic component according to claim 1, wherein the mounting surface of the interposer substrate includes a length direction margin region where the first bonding electrode and the second bonding electrode are not provided, outward in the length direction from an end portion of the first bonding electrode in the length direction or an end portion of the second bonding electrode in the length direction.

14. The multilayer electronic component according to claim 2, wherein the mounting surface of the interposer substrate includes a length direction margin region where the first bonding electrode and the second bonding electrode are not provided, outward in the length direction from an end portion of the first bonding electrode in the length direction or an end portion of the second bonding electrode in the length direction.

15. The multilayer electronic component according to claim 3, wherein the mounting surface of the interposer substrate includes a length direction margin region where the first bonding electrode and the second bonding electrode are not provided, outward in the length direction from an end portion of the first bonding electrode in the length direction or an end portion of the second bonding electrode in the length direction.

16. The multilayer electronic component according to claim 1, wherein the mounting surface of the interposer substrate includes a second direction margin region where the first bonding electrode and the second bonding electrode are not provided, outward in the second direction from each of the end portions of the first bonding electrode in the second direction or each of the end portions of the second bonding electrode in the second direction.

17. The multilayer electronic component according to claim 2, wherein the mounting surface of the interposer substrate includes a second direction margin region where the first bonding electrode and the second bonding electrode are not provided, outward in the second direction from each of the end portions of the first bonding electrode in the second direction or each of the end portions of the second bonding electrode in the second direction.

18. The multilayer electronic component according to claim 3, wherein the mounting surface of the interposer substrate includes a second direction margin region where the first bonding electrode and the second bonding electrode are not provided, outward in the second direction from each of the end portions of the first bonding electrode in the second direction or each of the end portions of the second bonding electrode in the second direction.

19. The multilayer electronic component according to claim 14, wherein the mounting surface of the interposer substrate includes a second direction margin region where the first bonding electrode and the second bonding electrode are not provided, outward in the second direction from each of the end portions of the first bonding electrode in the second direction or each of the end portions of the second bonding electrode in the second direction.

20. The multilayer electronic component according to claim 15, wherein the mounting surface of the interposer substrate includes a second direction margin region where the first bonding electrode and the second bonding electrode are not provided, outward in the second direction from each of the end portions of the first bonding electrode in the second direction or each of the end portions of the second bonding electrode in the second direction.
